(19) United States
(12) Patent Application Publication
(10) Pub. No.: US 2008/0309492 A1
(43) Pub. Date: Dec. 18, 2008

(54) METHOD AND SYSTEM FOR MONITORING AND MANAGING STATUS OF LUGGAGES IN AN AIRPORT USING RFID

(76) Inventor: Tarik Mihoubi, Montreal (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/137,627

(22) Filed: Jun. 12, 2008

Related U.S. Application Data
(60) Provisional application No. 60/943,359, filed on Jun. 12, 2007.

(51) Int. Cl. G08B 13/14

(52) U.S. Cl. 340/572.1

(57) ABSTRACT

The present invention relates to a method of monitoring and intercepting a suspect object in an airport using RFID, the method comprising associating a RFID tag with the object, transmitting an inquiry signal associated with the RFID tag, where the RFID tag is adapted to receive the inquiry signal and to transmit a response signal associated with the RFID tag, receiving the response signal transmitted by the RFID tag, determining a status of the object using the response signal, and transmitting an alert signal associated with the object as a function of the determined status, if requested.

### CROSS-REFERENCE TO RELATED APPLICATIONS

The present application claims the benefits of commonly assigned provisional U.S. Patent Application No. 60/943,359, filed on Jun. 12, 2007.

### FIELD OF THE INVENTION

The present invention relates to a method and a system using Radio Frequency Identification (RFID) for monitoring and determining security status of luggages and passengers in an airport.

### BACKGROUND OF THE INVENTION

Items manipulations such as luggage at airports, train stations and the like are complex due to the volume that needs to be processed as well as the handling which includes security checks, loading/unloading, identification etc. Errors in handlings results in losses, delay, unsafe loads that are all costly to the carrier.

Existing systems are based predominantly on simple detection systems such as bar code tracking systems which provide limited amounts of information on the labeled item.

Moreover, today's airports are not equipped with reliable security systems capable of monitoring and tracking suspect luggages and persons in airports.

For example, traditionally, luggages and passengers are not scanned, monitored and tracked in the destination airport. In part, this is due to the absence of convenient technologies that would facilitate monitoring and intercepting suspect luggages and persons in destination airports. Thus, traditionally, if a passenger manages to pass dangerous material through the departure airport, he would most likely be able to enter the given material in the destination country.

Besides, when the passenger passes through a first check point area in an airport (ex. the x-ray check point), there is no traditional security systems for tracking these passengers between this first check point area and a further check point area. The absence of such a system would leave a potential terrorist in the shadow between these two check points, and would give him the facility to perpetrate terrorist acts in that area.

Moreover, traditionally, different airports in the world could not share their respective security data. This is due to the absence of a convenient technology that would allow communication between the correspondent database management systems associated thereto.

### SUMMARY OF THE INVENTION

As a first aspect of the invention, there is provided a method for monitoring status of items, the method comprising:
a) tagging the items with a detectable tag containing information related to the item;
b) updating the status based on information acquired at one or more check point; and
c) providing status update to a user.

The method preferably further comprises detecting the tag at one or more check point.

The step of tagging preferably comprises incorporating the information in the tag.

The step of detecting preferably comprises reading the tag with a reader operated automatically or by a user.

The reader is preferably identified and has information associated therewith.

The updating is preferably performed automatically by registering the information associated with the reader with the items.

The updating is preferably performed by a user whereby the user provides information that is associated with the item.

The items are preferably luggages or containers. The luggages or containers are preferably monitored in an airport or port.

The acquiring the information and the updating the status preferably comprises accessing a database using a universal interface (Aerosoft) adapted to access any existing type of database used in any airport in the world.

As another aspect of the invention, there is provided a system for managing handling of items, the system comprising:
a) remotely detectable information containing tags to tag the items;
b) detector/reader to read the tags;
c) data storage means to store information detected by the detector/reader; and
d) display to display the information to a user.

The system preferably further comprises means to notify a user of status of the items.

The system preferably further comprises means to encode information on the tag.

The system preferably further comprises a universal interface (Aerosoft) adapted to access any existing type of database used in any airport in the world.

In a further aspect of the invention, there is provided a method of monitoring and intercepting a suspect object in an airport using RFID, the method comprising
a) associating a RFID tag with the object;
b) transmitting an inquiry signal associated with the RFID tag, where the RFID tag is adapted to receive the inquiry signal and to transmit a response signal associated with the RFID tag;
c) receiving the response signal transmitted by the RFID tag;
d) determining a status of the object using the response signal; and
e) transmitting an alert signal associated with the object as a function of the determined status, if requested.

The method preferably further comprises storing security information in connection with the object, wherein the determining a status of the object is carried out as a function of the security information.

In a first embodiment, the RFID tag has a memory, the storing the security information comprises storing the security information in the memory, the transmitted response signal comprises the security information, and the receiving the response signal comprises reading the security information transmitted by the response signal.

In a second embodiment, the method thee RFID tag has a memory comprising a unique identification code associated with the object, the storing security information comprises storing the security information in a security database, the transmitted response signal comprises the unique identification code, the receiving the response signal comprises reading the unique identification code transmitted by the response signal and, the determining a status of the object comprises using the unique identification code to extract the security information from the security database.

The determined status can indicate that the object is suspect, said method further comprising intercepting the object.

The object can be a luggage, and the associating an RFID tag with the object comprises placing the RFID tag on the luggage.

Preferably, the placing the RFID tag on the luggage is carried out within a first passenger check point area in the airport, and the inquiry and response signals are received exclusively within a second passenger check point area in the airport.

The object can also be a passenger.

As a further aspect of the invention, there is provided a method of monitoring an object between two passenger check point areas in an airport using RFID, the method comprising:
a) associating a RFID tag with the object;
b) transmitting a first inquiry signal associated with the RFID tag, where the RFID tag is adapted to receive the first inquiry signal and to transmit a first response signal, where the first inquiry signal is received exclusively within a first passenger check point area in the airport;
c) determining a first location of the object using the first response signal;
d) transmitting a second inquiry signal associated with the RFID tag, where the RFID tag is adapted to receive the second inquiry signal and to transmit a second response signal, where the second inquiry signal is received exclusively within a second passenger check point area in the airport;
e) determining a second location of the object as a function of reception of the second response signal or lack thereof,
f) determining a status of the object using the determined first and second locations; and
g) transmitting an alert signal associated with the object as a function of the determined status, if requested.

In a first embodiment of the invention, the RFID tag has a memory, the method further comprising storing location data in connection with the first and second determined locations in the memory, the transmitted response signals comprise the location data, and the determining a status of the object comprises extracting the location data from the response signal.

In a second embodiment of the invention, the RFID tag has a memory comprising a unique identification code associated with the object, the method further comprising storing location data in connection with the first and second determined locations in a security database, the transmitted response signal comprises the unique identification code, the receiving the response signal comprises reading the unique identification code transmitted by the response signal and, the determining a status of the object comprises using the unique identification code to extract the location data from the security database.

In an other aspect of the invention, there is provided a system for sharing data between a plurality of airport database management systems, the system comprising:
a) a network;
b) a server;
c) a first module connected to the network for receiving a first data having a first database data format communicated by a first airport database management system, the first module being connected to the server for storing in the server the first data according to the first database data format;
d) a conversion module connected to the server for receiving the first data and converting the first data having the first database data format into a converted data having a second database data format, the conversion module being connected to the server for storing in the server the converted data; and
e) a second module connected to the server for extracting the converted data from the server and transmitting the converted data to a second airport database management system.

Preferably, the system further comprises:
a) RFID tags adapted to be associated to objects in an airport;
b) a RFID transmitter for transmitting inquiry signals associated with the RFID tags, where the RFID tags are adapted to receive the inquiry signals and to transmit response signals associated with the RFID tags; and
c) a RFID receiver for receiving the response signals transmitted by the RFID tags, the receiver comprising a demodulation module connected to the first database management system for demodulating the response signals into the first data and storing the first data into the first database-management system.

### DETAILED DESCRIPTION OF THE INVENTION

There is provided a method for managing items transiting in a travel depot such as an airport or a seaport. In one embodiment, the items are identified by a tag that is remotely detectable such that information associated with the tag can be monitored without visual inspection. In particular the method enables monitoring the status of objects or items and to update the status of the objects or items.

The information encoded in the tag may comprise an item identifier such as an alphanumeric identification, item characteristics (content, weight, etc), information regarding the traceability of the item (owner, destination etc).

The updating of the status of items is achieved by providing a communication system by which information about the items can be detected and updated and be presented to a user to facilitate management of the items.

In one embodiment, the information is updated by registering information associated with detectors with the object. Thus, it is possible to automatically update the status of an item by detecting and reading the information on a tag at a particular checkpoint whereby the checkpoint is associated with a given set of information data.

In another embodiment, the update on the status of the object is performed by a user who can detect using a portable reader, the identity of the object and communicate to the system certain information regarding the status of the item.

In one aspect the method also comprises the inputting of information on the tag so as to update the status of the item. Thus at different stages of the item itinerary information can be added either automatically or by a user.

The method also comprises feedback steps by which the status of the item is updated at a control station or user accessible database.

The method also comprises using a universal interface integrated software (Aerosoft), capable of communicating with any existing type of database used in any airport in the world. The given software with the integrated universal interface would be able to communicate with any existing database for registering luggages and transit information of travelers.

The method advantageously allows the tracing of the item. In particular the method ensure traceability at different steps which for a luggage may include registration, security check, sorting and recovery of luggage.

In another aspect, there is provided a system comprising a remotely detectable tag, detectors and computer devices operatively coupled to the detectors to acquire information encoded in the tag and associated with the reader. The system also comprises display means for providing users with information regarding the status of objects.

In an exemplary embodiment of the invention the method is used for managing luggage in an airport. A tag is affixed to the luggage and contains information regarding the tag ID, a luggage ID, name of the passenger, flight number, flight destination, weight of luggage, status of the luggage (i.e. security checks, in plane, recovered etc.). This information can be encoded in the tag at the registration.

The method of the present invention allows for an efficient security control which involves the update of the status regarding security of the item, either manually or automatically. The identification of suspicious luggage can be done by writing information on the tag already assigned to the luggage, or alternatively, by providing information to the system that the status of a particular luggage has changed.

New tags can also be added along the itinerary of the luggage.

In yet another embodiment, identification and changing of the status of an item can be effected by sorting the items and directing the sorted items to a designated reader, which will associate particular information with each item detected by this reader.

For example, if it is desired to identify luggage as being suspicious, but in need of further inspection, it is possible to redirect the suspicious luggage towards a particular detector, which will then communicate to the system that the luggage is suspicious and in need of further verification.

In another example, the luggage can be sorted according to their final destination and feedback can be provided to the system to confirm that the luggage has been sorted.

In a preferred embodiment, the system is based on radio frequency identification (RFID), which allows for rapid and automated data acquisition wirelessly. As would be appreciated by a person skilled in the art, appropriate measures should be taken to avoid interference between the frequency and signals originating from the tags and the readers and other frequency sensitive devices.

1. A method for monitoring status of items, the method comprising:
a) tagging said items with a detectable tag containing information related to said item;
b) updating said status based on information acquired at one or more check point; and
c) providing status update to a user.

2. The method as claimed in claim 1, further comprising detecting said tag at one or more check point.

3. The method as claimed in claim 1, wherein said step of tagging comprises incorporating said information in said tag.

4. The method as claimed in claim 2, wherein said step of detecting comprises reading said tag with a reader operated automatically or by a user.

5. The method as claimed in claim 4, wherein said reader is identified and has information associated therewith.

6. The method as claimed in claim 5, wherein said updating is performed automatically by registering the information associated with the reader with the items.

7. The method as claimed in claim 1, wherein said updating is performed by a user whereby said user provides information that is associated with the item.

8. The method as claimed in claim 1, wherein said items are luggages or containers.

9. The method as claimed in claim 8, wherein said luggages or containers are monitored in an airport or port.

10. The method as claimed in claim 1, wherein said acquiring said information and said updating said status comprises accessing a database using a universal interface (Aerosoft) adapted to access any existing type of database used in any airport in the world.

11. A system for managing of items, said system comprising:
a) remotely detectable information containing tags to tag said items;
b) a detector/reader to read said tags;
c) data storage means to store information detected by said detector/reader; and
d) a display to display said information to a user.

12. The system as claimed in claim 11, further comprising means to notify a user of status of said items.

13. The system as claimed in claim 11, further comprising means to encode information on said tag.

14. The system as claimed in claim 11, further comprising a universal interface (Aerosoft) adapted to access any existing type of database used in any airport in the world.

15. A method of monitoring and intercepting a suspect object in an airport using RFID, the method comprising:
a) associating a RFID tag with said object;
b) transmitting an inquiry signal associated with said RFID tag, where said RFID tag is adapted to receive said inquiry signal and to transmit a response signal associated with said RFID tag;
c) receiving said response signal transmitted by said RFID tag;
d) determining a status of said object using said response signal; and
e) transmitting an alert signal associated with said object as a function of said determined status, if requested.

16. The method as claimed in claim 15, further comprising storing security information in connection with said object, wherein said determining a status of said object is carried out as a function of said security information.

17. The method as claimed in claim 16, wherein said RFID tag has a memory, said storing said security information comprises storing said security information in said memory, said transmitted response signal comprises said security information, and said receiving said response signal comprises reading said security information transmitted by said response signal.

18. The method as claimed in claim 16, wherein said RFID tag has a memory comprising a unique identification code associated with said object, said storing security information comprises storing said security information in a security database, said transmitted response signal comprises said unique identification code, said receiving said response signal comprises reading said unique identification code transmitted by said response signal and, said determining a status of said object comprises using said unique identification code to extract said security information from said security database.

19. The method as claimed in claim 15, wherein said determined status indicates that said object is suspect, said method further comprising intercepting said object.

20. The method as claimed in claim 15, wherein said object is a luggage, and said associating an RFID tag with said object comprises placing said RFID tag on said luggage.

21. The method as claimed in claim 20, wherein said placing said RFID tag on said luggage is carried out within a first passenger check point area in said airport, and said inquiry and response signals are received exclusively within a second passenger check point area in said airport.

22. The method as claimed in claim 15, wherein said object is a passenger.

23. A method of monitoring an object between two passenger check point areas in an airport using RFID, the method comprising:
a) associating a RFID tag with said object;
b) transmitting a first inquiry signal associated with said RFID tag, where said RFID tag is adapted to receive said first inquiry signal and to transmit a first response signal, where said first inquiry signal is received exclusively within a first passenger check point area in said airport;
c) determining a first location of said object using said first response signal;
d) transmitting a second inquiry signal associated with said RFID tag, where said RFID tag is adapted to receive said second inquiry signal and to transmit a second response signal, where said second inquiry signal is received exclusively within a second passenger check point area in said airport;
e) determining a second location of said object as a function of reception of said second response signal or lack thereof,
f) determining a status of said object using said determined first and second locations; and
g) transmitting an alert signal associated with said object as a function of said determined status, if requested.

24. The method as claimed in claim 23, wherein said RFID tag has a memory, said method further comprising storing location data in connection with said first and second determined locations in said memory, said transmitted response signals comprise said location data, and said determining a status of said object comprises extracting said location data from said response signal.

25. The method as claimed in claim 23, wherein said RFID tag has a memory comprising a unique identification code associated with said object, said method further comprising storing location data in connection with said first and second determined locations in a security database, said transmitted response signal comprises said unique identification code, said receiving said response signal comprises reading said unique identification code transmitted by said response signal and, said determining a status of said object comprises using said unique identification code to extract said location data from said security database.

26. The method as claimed in claim 23, wherein said object is a luggage, and said associating an RFID tag with said object comprises placing said RFID tag on said luggage.

27. The method as claimed in claim 23, wherein said object is a passenger.

28. A system for sharing data between a plurality of airport database management systems, the system comprising:
a) a network;
b) a server;
c) a first module connected to said network for receiving first data having a first database data format communicated by a first airport database management system, said first module being connected to said server for storing in said server said first data according to said first database data format;
d) a conversion module connected to said server for receiving said first data and converting said first data having said first database data format into a converted data having a second database data format, said conversion module being connected to said server for storing in said server said converted data; and
e) a second module connected to said server for extracting said converted data from said server and transmitting said converted data to a second airport database management system.

29. A system as claimed in claim 28, further comprising:
a) RFID tags adapted to be associated to objects in an airport;
b) a RFID transmitter for transmitting inquiry signals associated with said RFID tags, where said RFID tags are adapted to receive said inquiry signals and to transmit response signals associated with said RFID tags; and
c) a RFID receiver for receiving said response signals transmitted by said RFID tags, said receiver comprising a demodulation module connected to said first database management system for demodulating said response signals into said first data and storing said first data into said first database management system.
